(19) United States
(12) Patent Application Publication
(10) Pub. No.: US 2012/0166534 A1
(43) Pub. Date: Jun. 28, 2012

(54) SYSTEM AND METHOD FOR GROUPING CONFERENCE PARTICIPANTS

(75) Inventors: Jon L. BENTLEY, New Providence, NJ (US); Anjur S. KRISHNAKUMAR, Princeton, NJ (US); Parameshwaran KRISHNAN, Basking Ridge, NJ (US); Navjot SINGH, Denville, NJ (US); Shalini YAJNIK, Berkeley Heights, NJ (US)

(73) Assignee: Avaya Inc., Basking Ridge, NJ (US)

(21) Appl. No.: 12/978,745

(22) Filed: Dec. 27, 2010

(51) Int. Cl. G06F 15/16

(52) U.S. Cl. 709/204

(57) ABSTRACT

Disclosed herein are systems, methods, and non-transitory computer-readable storage media for grouping e-conference participants. A system identifies participants for an e-conference and identifies groups based on e-conference participant characteristics. Participant characteristics such as job function, skill set, department, business unit or physical location are used to group participants. Each of the e-conference participants is associated with at least one group and the system visually displays participants in groups through an e-conference user interface. Additionally, the system retrieves a stored list of e-conference participants and groups from a previous e-conference and restores the list of participants and groups for a current e-conference.

### BACKGROUND

1. Technical Field

The present disclosure relates to conferences and more specifically to grouping e-conference participants.

2. Introduction

In the business world, it is often necessary to conduct meetings with people at other physical locations, including those within the same company and those from different companies. E-conferencing is one method for a group of people to communicate with each other without physically being in the same location. An e-conference is an electronic conference that allows for one or more participants to conference electronically instead of requiring the participants to physically travel to the conference location, such as a conference call, video conference, or other multiparty communication session where at least two parties are not in a same location. Utilizing e-conferences can significantly reduce the costs of meeting since participants do not need to travel to the conference location. Many businesses and organizations utilize e-conferencing to accomplish their objectives economically.

To schedule an e-conference, participants can send their availability to all other participants and a mutually agreed upon time and date for the e-conference to occur is established by the participants. Optionally, an e-conference participant or scheduler schedules the e-conference based on availability as indicated in a digital calendaring system. At the scheduled time, participants connect to the e-conference.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for grouping e-conference participants. The method is discussed in terms of a system implementing the method. The system identifies e-conference participants and identifies groups based on e-conference participant characteristics. E-conference participant characteristics can include job function, skill set, department, business unit, physical location, participant speech history, and so forth. The groups can be further identified based on participant role, participant location, participant preferences, discussion content and participant speech characteristics. Each of the e-conference participants can be associated with at least one group and the grouping of participants can be displayed in a e-conference user interface. Displaying participants in groups allows for e-conference participants to easily view the characteristics of those on the e-conference and also allows participants to view how participants dynamically move between groups during the e-conference.

In another aspect, the system retrieves a stored list of groups and e-conference participants from a previous e-conference and restores the list of groups and e-conference participants for a current e-conference.

One or more e-conference participants can “freeze” the groups in a particular configuration to prevent additional changes to the groups. Each e-conference participant can have a different groups view. For instance, a first participant can provide a first set of characteristics that are important to the first participant. Then the first participant's conference device can group the participants according to the first set of characteristics. A second participant on the same e-conference as the first participant can provide a second set of characteristics that are important to the second participant. Then the second participant's conference device can group the participants according to the second set of characteristics. Even though both the first and the second participants view the same e-conference, their respective displays can provide widely differing groups and/or participants based on their respective sets of important characteristics.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example participant grouping method embodiment;

FIG. 3 illustrates an example call list restoration method embodiment;

FIG. 4 illustrates grouping e-conference participants;

FIG. 5 illustrates modifying e-conference grouping; and

FIG. 6 illustrates merging and removing e-conference grouping;

FIG. 7 illustrates an example user interface system.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

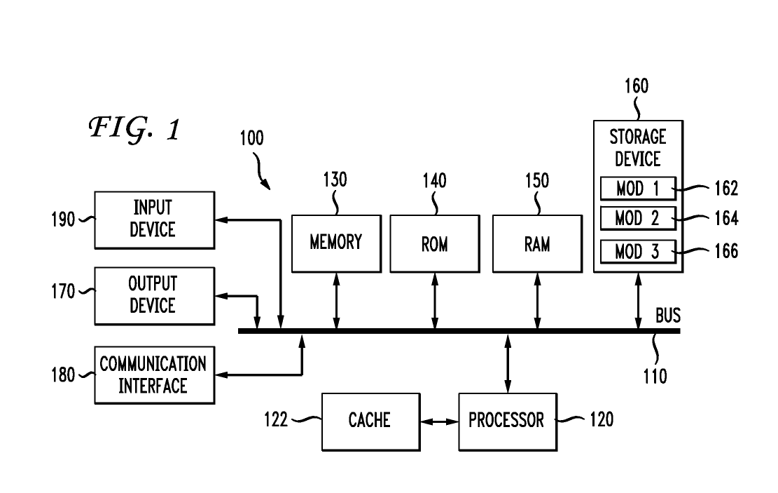

The present disclosure addresses the need in the art for grouping e-conference participants. A system, method and non-transitory computer-readable media are disclosed which group e-conference participants based on various participant characteristics and otherwise manage conference participant groups. A brief introductory description of a basic general purpose system or computing device in FIG. 1 which can be employed to practice the concepts is disclosed herein. A more detailed description of grouping e-conference participants will then follow. These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache of high speed memory connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

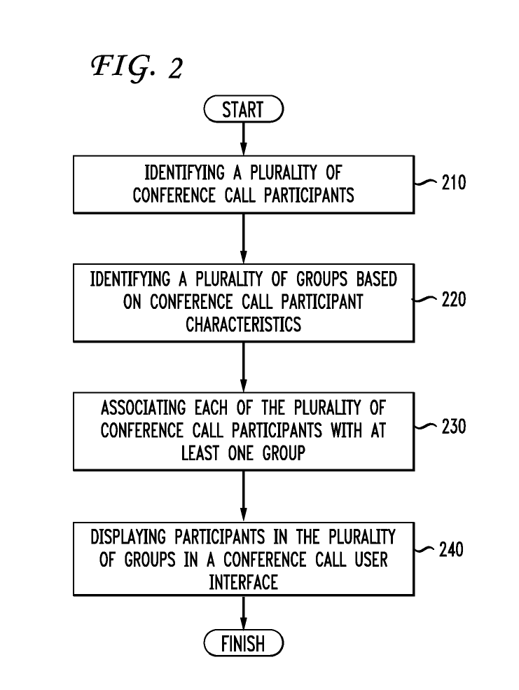

Having disclosed some basic system components and concepts, the disclosure now turns to the exemplary method embodiment shown in FIG. 2. For the sake of clarity, the method is discussed in terms of an exemplary system 100 as shown in FIG. 1 configured to practice the method. The steps outlined herein are exemplary and can be implemented in any combination or permutation thereof, including combinations that exclude, add, or modify certain steps.

FIG. 2 illustrates grouping conference participants based on characteristics of the respective conference participants. The system 100 identifies conference participants 210 and identifies groups based on conference participant characteristics 220. Each of the conference participants is associated with at least one group 230. By default, the system groups all participants into the conference group. Optionally, participants are added to additional groups based on participant characteristics. Once participants are associated with groups, the system displays participants 240 in their respective groups in a conference user interface.

Identifying groups to logically organize conference participants is accomplished using various participant characteristics. Conference participant characteristics include job function, skill set, department, business unit and physical location. For example, groups involving job function are secretary, manager, engineer, while groups involving department are accounting, law or engineering. Groups determined by skill set can include those participants with a mathematical background, for example. Groups can also be determined by the physical location that a participant works such as Washington, D.C., San Francisco, or Houston. Groups can even be more geographically precise, such as based on a particular floor or wing of an office building.

The groups can be further identified based on participant role, participant location, participant preferences, discussion content and participant speech characteristics. For example, groups based on participant role are moderators and participants and groups based on discussion content are budget, project timeline and project delay. Groups can be determined by participant speech characteristics such as participants who speak the most, participants who speak the least, and participants who have not yet spoken. Groups can be determined by where a participant is physically located during the e-conference. For example, a participant works out of the Houston office, but joins the e-conference while traveling to Austin. The system can group the traveling participant accordingly, for instance en route to Austin or away from the office.

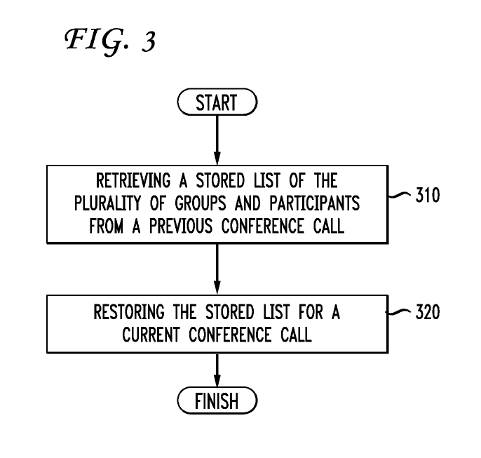

FIG. 3 illustrates restoring a stored list of e-conference participants and groups from a previous e-conference. In one aspect, the system 100 retrieves a stored list of groups and participants from a previous e-conference 310. The list of groups and participants from the stored list is restored for the current e-conference. Restoring groups and participants from a previous call allows current participants to view the history of call participants. For example, when the stored list includes groups based on participant speech characteristics such as the participants who speak the most, current participants can expect certain participants to speak frequently in the current call. When the stored list includes groups based on job function, current e-conference participants can view the job functions of those participating in the e-conference when they otherwise would not know the job function of participants. Utilizing groups from previous e-conferences allow current participants to better understand and more effectively communicate with those in the e-conference.

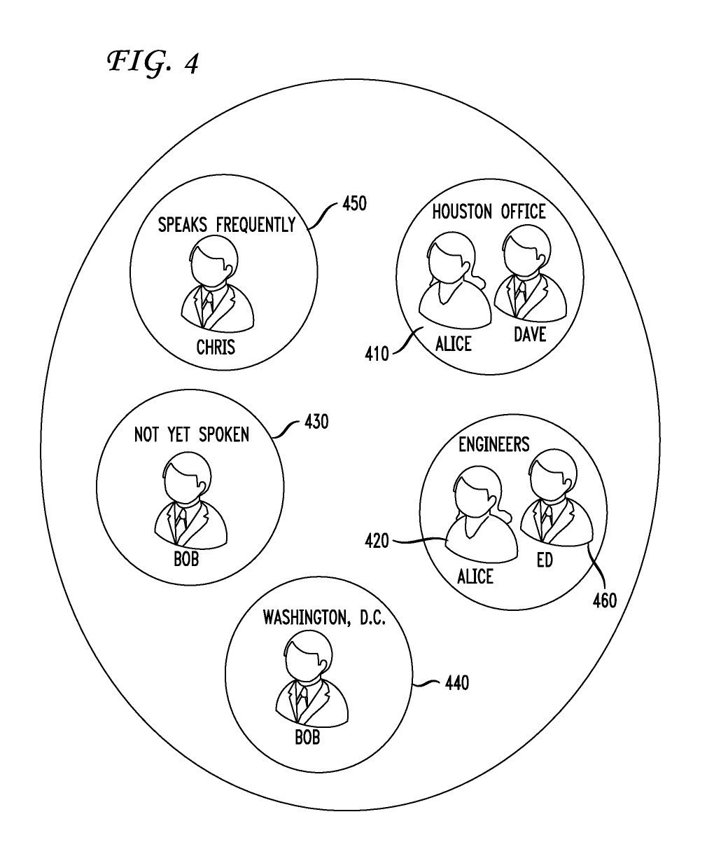

In one aspect, each participant must be grouped into at least one group, however participants can be included in multiple groups. By default, each participant belongs to the e-conference group. Optionally, participants are added to other groups. Some participants may not be assigned to any group other than the default e-conference group which includes all participants. The system 100 adds participants to the default e-conference group when they connect to the e-conference and removes them from the default group when they disconnect from the e-conference. FIG. 4 illustrates the grouping of participants into more than one group. For example, participants Alice, Bob, Chris, Dave and Ed are conferencing on an e-conference and each participant is grouped into at least one group in addition to the default group. Although it is not necessary for a participant to be in more than one group, some participants are grouped into multiple groups. The system groups Alice as both working in the Houston office 410 and as an engineer 420. The system groups Bob as not having spoken 430 in the current e-conference and as working in the Washington, D.C. office 440. Chris is only grouped as a frequent speaker 450.

Since the system provides a visual display of the current groups for all participants, participants have more information about each other. From the visual display of groups, Alice learns that Ed is also an engineer 460 and that Chris speaks frequently 450. Alice can utilize this knowledge during the e-conference by expecting Chris to speak frequently and by directly asking Ed questions about engineering.

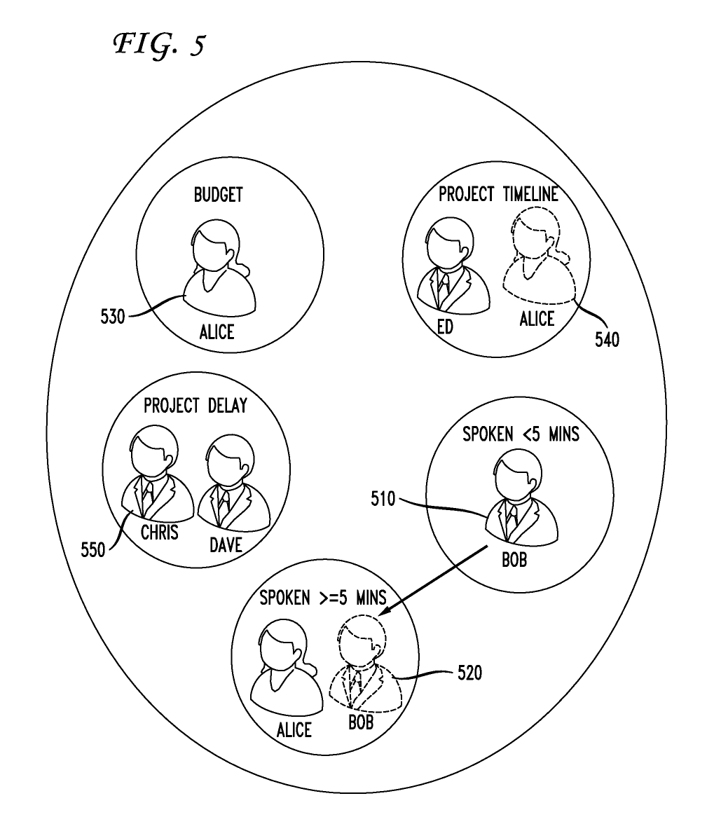

The visual display provides group updating throughout the duration of the conference. FIG. 5 illustrates how participants move between groups throughout the call. For example, initially the system groups Bob as not having yet spoken 510, but moves him to the spoken group 520 after he addresses the participants in the e-conference. The system groups Alice as mostly participating in the budget discussions 530, but adds her to the project timeline group 540 as well as the budget group 530 after she participates in a certain minimum of project timeline discussions. The system provides group updating dynamically throughout the duration of the e-conference based on participant characteristics.

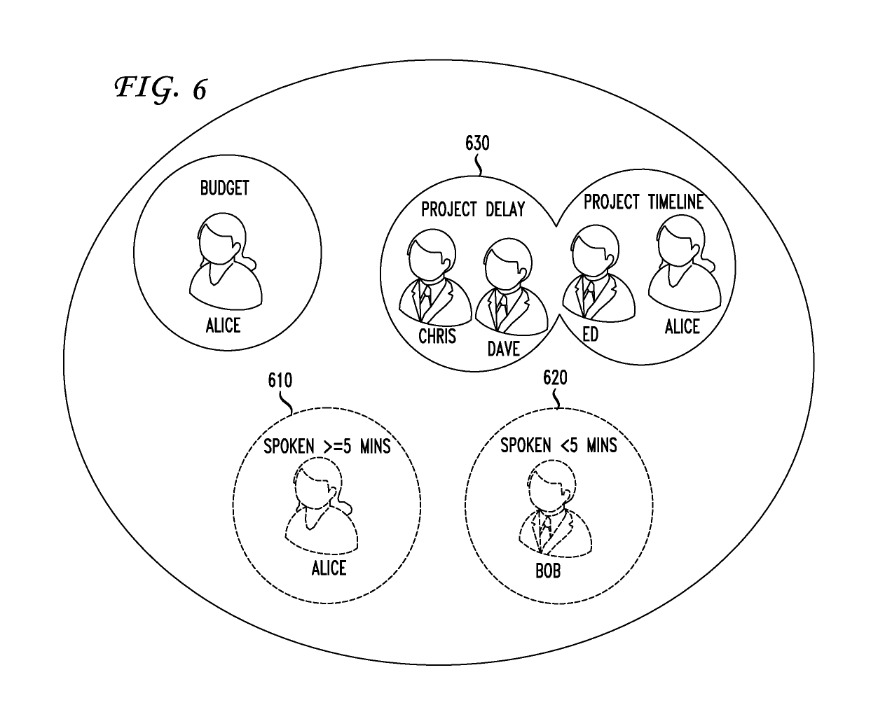

In addition to the system dynamically grouping participants in an e-conference, participants can group any of the other participants and/or themselves through the user interface using drag and drop, touch gestures, voice commands, and so forth. Other methods of grouping participants exist such as providing input via a textbox, drop-down menu, a microphone, an email, a text message, etc. Users can add, modify or delete their own groups or groups automatically generated by the system. If the system groups Chris as participating in discussions about project delay 550, but Chris provides important information about the budget, a user can optionally add Chris to the budget group. The user can remove Chris from the project delay group or allow him to be grouped into multiple groups based on discussion topic. For example, a user does not want participants grouped by the frequency with which they participate in the e-conference and can delete the groups relating to how often a participant speaks, such as the spoken and not spoken groups. FIG. 6 illustrates a user managing e-conference grouping. FIG. 6 reflects the grouping of e-conference participants after the user removes the spoken 610 and not spoken 620 groups. Additionally, the user decides that the project delay and project timeline groups do not need to be separate and merges the two groups in to one group 630. The visual display updates to reflect the grouping preferences specified by the user.

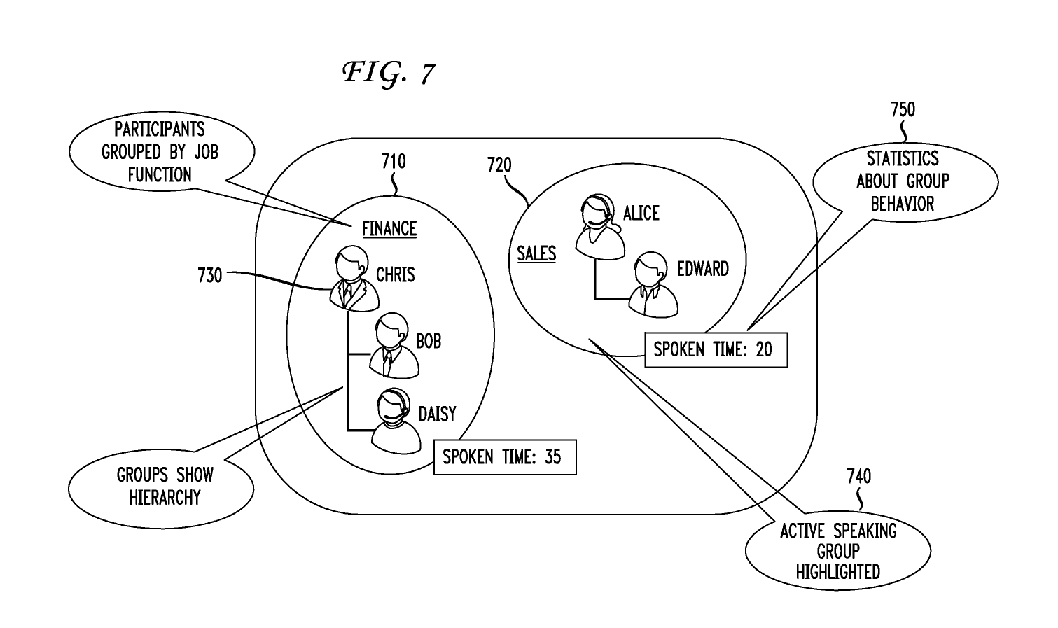

FIG. 7 illustrates an example user interface for grouping e-conference participants. The user interface displays participants grouped by job function such as finance and sales 710, 720. The groups show all or part of a hierarchy, for example, by displaying Chris at the top of the finance group and displaying Bob and Daisy lower on the hierarchy. The interface shows which group contains the participant that is currently speaking by highlighting the group 740. For example, when Alice speaks, the system can highlight the sales group. When Bob speaks, the system can highlight the finance group. The interface can show statistics about group behavior such as how much time a group has spent talking during the e-conference 750. The illustration serves as an exemplary user interface and should not be limiting in any way. The user interface need not contain all of the aforementioned functions and may contain other functions such as participants grouped by years of experience or skill set. The system can show links between hierarchies, such as to illustrate a hierarchy of groups as well as hierarchies within each group. For example, a finance group can be above a marketing group, and the marketing group can be above a sales group.

In addition to the system generating and managing grouping participants for conferences, the system can alert users of particular groups when a topic of interest to those users is being discussed. For example, the system 100 can send an email to the budget group when the moderator indicates that it is time to discuss the budget. Alternately, the system can provide feedback visually such as changing a shape, color, thickness, and/or other visual attribute associated with the group of interest. The system can visually represent each group with a circle and the names of participants associated with each group in the circle, where the circle is colored yellow. The system can indicate to the group of interest that the current topic is of interest by changing the color from yellow to green, or flashing the color in the circle to attract their attention. The system can use colors for varying purposes, such as indicating the group in which the participant belongs that is currently speaking, or indicating that a particular group has spoken for their allotted time. The system can track the amount of time a group speaks and when a certain threshold of time is reached, the system can change the group color to red indicating to the group that they have spoken for their allotted time, thus allowing other groups to speak up. Further, the system can add a tooltip, overlaid text, or other indication of the amount of time a group has spoken, for example. The system can provide, in the user interface, a summary or status of each group based on one or more characteristics of the group. The user interface can also display buttons or a menu providing users with easy access to common group management tasks (such as merge, split, manage group members, etc.).

Participants can perform other actions through the user interface, such as muting, sending messages, and recording participants in particular groups. Participants can mute the e-conference when participants in a certain group are speaking This option is useful for a user that is multi-tasking and only wants to listen to information relevant to his particular job or function. Participants can communicate via text message, instant message, or e-mail, for example, with participants that belong to a particular group for side-channel discussions during the e-conference. For example, Alice can send additional budgeting information stored in a spreadsheet via e-mail to the participants in the project delay group. Additionally, participants can record the e-conference when members of certain groups are speaking For example, Ed is a member of the project timeline group and can record comments from the project delay group. Recording comments from certain groups allows participants to review important discussions from the e-conference at a later time.

The user interfaces can be adapted for desktop, laptop, tablet, mobile phone, and other mobile device interfaces according to the display, communication, processing, connectivity, and other device capabilities. For instance, a desktop having a high-end video card can make use of the video card and the large display to provide an interface having animations, displaying group metadata, providing detailed interactions, and so forth. A mobile phone having a much smaller display and less processing power, for example, can provide a way for users to browse between groups, only showing a single group at a time. The mobile phone can also automatically switch back and forth to show an actively participating group during the conference.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method of grouping e-conference participants via a user interface, the method comprising:
identifying a plurality of e-conference participants;
identifying a plurality of groups based on e-conference participant characteristics;
associating each of the plurality of e-conference participants with at least one group of the plurality of groups; and
displaying participants in the plurality of groups in an e-conference user interface.

2. The method of claim 1, wherein the e-conference user interface displays a speaker as a group instead of as an individual participant.

3. The method of claim 1, wherein the e-conference participant characteristics comprises at least one of job function, skill set, department, business unit or physical location.

4. The method of claim 1, wherein each of the plurality of e-conference participants is associated with at least one group of the plurality of groups dynamically based on which participants are speaking.

5. The method of claim 1, wherein the plurality of groups is identified further based on discussion content.

6. The method of claim 1, wherein the plurality of groups is identified further based on participant role, participant location, participant job function, and participant speech characteristics.

7. The method of claim 1, wherein the e-conference user interface updates during an e-conference based on how participants move among groups.

8. The method of claim 1, wherein the plurality of groups is identified further based on their participant preferences.

9. The method of claim 1, further comprising:
retrieving a stored list of the plurality of groups and e-conference participants from a previous e-conference; and
restoring the stored list of the plurality of groups and e-conference participants for a current e-conference.

10. The method of claim 1, wherein the plurality of groups is identified further based on a previous e-conference grouping.

11. The method of claim 1, wherein the e-conference user interface provides visual feedback indicating which groups are currently talking, the amount of time spent talking by a particular group, and which groups have not spoken.

12. The method of claim 1, further comprising alerting e-conference participants associated with a particular group when a topic of discussion relates to the particular group.

13. The method of claim 1, wherein the plurality of groups is identified further based on input from an e-conference moderator.

14. The method of claim 13, wherein the e-conference moderator identifies the plurality of groups based on an agenda for the e-conference.

15. A system for grouping e-conference participants via a user interface, the system comprising:
a processor;
a first module configured to control the processor to identify a plurality of e-conference participants;
a second module configured to control the processor to identify a plurality of groups based on e-conference participant characteristics;
a third module configured to control the processor to associate each of the plurality of e-conference participants with at least one group of the plurality of groups; and
a fourth module configured to control the processor to display participants in the plurality of groups in a e-conference user interface.

16. The system of claim 15, wherein the e-conference user interface displays a speaker as a group instead of as an individual participant.

17. The system of claim 15, wherein the e-conference participant characteristics comprises at least one of job function, skill set, department, business unit or physical location.

18. A non-transitory computer-readable storage medium storing instructions which, when executed by a computing device, cause the computing device to group e-conference participants via a user interface, the instructions comprising:
identifying a plurality of e-conference participants;
identifying a plurality of groups based on e-conference participant characteristics;
associating each of the plurality of e-conference participants with at least one group of the plurality of groups; and
displaying participants in the plurality of groups in a e-conference user interface.

19. The non-transitory computer-readable storage medium of claim 18, further comprising:
retrieving a stored list of the plurality of groups and e-conference participants from a previous e-conference; and
restoring the stored list of the plurality of groups and e-conference participants for a current e-conference.

20. The non-transitory computer-readable storage medium of claim 18, wherein the e-conference user interface provides visual feedback indicating which groups are currently talking, the amount of time spent talking by a particular group, and which groups have not spoken.
